(19) United States
(12) Patent Application Publication
(10) Pub. No.: US 2012/0247413 A1
(43) Pub. Date: Oct. 4, 2012

(54) Engine Starting System

(76) Inventors: Antonio CICIRELLO, Collegno (IT); Luciano Marchitto, Pianezza (IT); Joseph Youqing Xiang, Canton, MI (US); Yue Li, Hong Kong (CN)

(21) Appl. No.: 13/436,088

(22) Filed: Mar. 30, 2012

(30) Foreign Application Priority Data
Mar. 30, 2011 (CN) 201110082738.3
Mar. 30, 2011 (CN) 201110082744.9

(51) Int. Cl. F02N 11/08

(52) U.S. Cl. 123/179.3

(57) ABSTRACT

A starting system for an internal combustion engine of a vehicle includes a second motor configured to drive a second load, a first motor configured to selectively drive either the engine or a first load, and a controller configured to control the first and second motors such that when the first motor drives the engine the second motor is stopped, and when the first motor drives the first load the second motor is controlled to drive the second load. Preferably, the second load is a cooling fan of a cooling system for the engine and the first load is a water pump of the cooling system.

### CROSS REFERENCE TO RELATED APPLICATIONS

This non-provisional patent application claims priority under 35 U.S.C. §119(a) from Patent Application No. 201110082738.3 filed in The People's Republic of China on Mar. 30, 2011, and from Patent Application No. 201110082744.9 filed in The People's Republic of China on Mar. 30, 2011.

### FIELD OF THE INVENTION

This invention relates to a starting system for an internal combustion engine of a vehicle.

### BACKGROUND OF THE INVENTION

A traditional vehicle has an engine starting system and an engine cooling system. The starting system includes a starter motor for starting the engine. The cooling system includes a cooling fan driven by a cooling fan motor and a water pump driven by a pump motor. Each motor has only one function. For example, the starter motor is used only to start the engine and the pump motor only drives the water pump.

The present invention aims to provide a new engine starting system.

### SUMMARY OF THE INVENTION

Accordingly, in one aspect thereof, the present invention provides a starting system for an internal combustion engine of a vehicle, comprising: a first electric motor connected to the engine and a first load; and a controller configured to control the first motor to selectively drive either the engine or the first load.

Preferably, a second electric motor is configured to drive a second load and the controller is configured to control the first and second motors such that when the first motor drives the engine the second motor is stopped, and when the first motor drives the first load the second motor is controlled to drive the second load.

Preferably, the first load is a water pump of a cooling system for the engine and the second load is a cooling fan of the cooling system.

Preferably, a first clutch is connected between the first motor and the engine and a second clutch is connected between the first motor and the first load.

Preferably, a gear train is connected between the first motor and the engine.

Preferably, the gear train is disposed between the first motor and the first clutch.

Preferably, the first motor has six phase windings.

Preferably, the controller is configured such that when the first motor drives the engine, the controller controls the first motor to operate as a six-phase motor, and when the first motor drives the first load the controller controls the first motor to operate as a three-phase motor.

Preferably, a power train control module is connected to the controller, and the power train control module is arranged to shut down the engine when the engine is not required.

Preferably, a number of sensors are provided associated with a brake pedal and an accelerator pedal of the vehicle and connected to the power train control module to indicate when the brake pedal and the accelerator pedal are pressed.

### BRIEF DESCRIPTION OF THE DRAWINGS

A preferred embodiment of the invention will now be described, by way of example only, with reference to the single figure of the accompanying drawings.

FIG. 1 is a schematic diagram of a start-stop system in accordance with the preferred embodiment of the present invention.

### DETAILED DESCRIPTION OF THE PREFERRED EMBODIMENTS

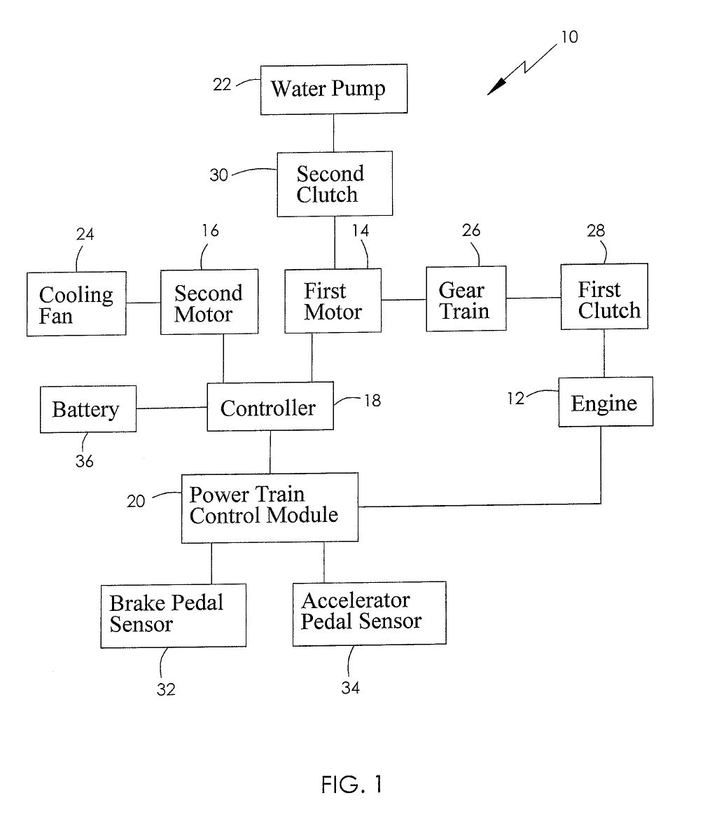

FIG. 1 is a schematic diagram of a starting system 10 for an internal combustion engine 12 in accordance with a preferred embodiment of the present invention. The engine has an associated cooling system to cool the engine during use. The starting system comprises: a first motor 14 connected to the engine 12 and a water pump 22 of the cooling system and configured to selectively drive either the engine or the water pump. A second motor 16 is configured to drive a cooling fan 24 of the cooling system. A controller 18 and a power train control module 20 and also provided.

The first motor is connected to a crank of the engine via a gear train 26, preferably via a flywheel. A first clutch 28 is connected between the first motor and the engine, preferable between the gear train and the engine, and a second clutch 30 is connected between the first motor and the water pump. The clutches allow the selective coupling of the first motor to the engine or to the water pump.

The controller is configured to control the operation of the first and second motors, as will be described herein after, and may be connected to a rechargeable battery 36. The clutches may be any suitable type of clutch which allows selective coupling of the first motor to the engine or water pump. For example, the clutches may be electro-magnetic clutches operated by the controller or they may be one way clutches (also known as over-running clutches) which allow the load to be coupled to the motor or disconnected there from depending on the rotational direction of the motor shaft. In the latter example, the controller controls the direction of the motor to selectively drive either the engine or the water pump.

In the start mode, when the engine is to be started, the second clutch disconnects the water pump from the first motor and the first clutch connects the first motor to the engine via the gear train and the first motor functions as a starter motor to start the engine. The gear train is optionally connected directly to the shaft of the first motor and the first clutch is physically disposed between the gear train and the engine. In this mode the controller stops operation of the second motor to conserve electrical power for starting the engine. After the engine has started, the system reverts to the run mode where the first clutch disconnects the first motor from the engine and the second clutch connects the first motor to the water pump, and the controller controls the first motor to drive the water pump and the second motor to drive the cooling fan.

The motors are electric motors and may be brushless direct current motors, internal permanent magnet motors, or other suitable types of motors.

Preferably, the first motor is a six-phase motor with six phase windings. During starting of the engine, the second motor stops working and the six phase windings of the first motor are all working to thereby provide high power for starting the engine. After the engine has started, the first motor is operated to drive the water pump and the second motor is operated to drive the cooling fan. However, three of the phase windings of the first motor are disconnected from the power source and the first motor operates as a three-phase motor while driving the water pump. As the cooling fan motor is turned off and the water pump is disconnected from the first motor during starting of the engine, more electrical power is available to the first motor for starting the engine. As the first motor is used to start the engine and to drive the water pump once the engine has been started, only two motors are required instead of three.

In the present invention, the controller controls two motors to drive three loads. Thus, compared to three controllers controlling three motors to drive three loads in the prior art, components are saved and space and cost are reduced.

Those skilled in the art will realize that the third load may be a load other than a water pump.

The starting system of the present invention may be used in a start-stop system. A stop-start system is where the engine is turned off or stopped when the vehicle is stopped and restarted when the vehicle is required to move. This leads to substantial fuel saving in city driving by avoiding periods in which the engine is idling. In the stop-start system, the power train control module 20 is connected to sensors 32, 34, associated with a brake pedal and an accelerator pedal for generating corresponding signals for the power train control module.

When the vehicle is brought to a standstill by depressing the brake pedal, the power train control module receives a stop signal from a corresponding sensor and the vehicle switches from the running mode to the stop mode. The engine is shut down under the control of the power train control module. When the brake pedal is released and the accelerator pedal is depressed, the power train control module receives a start signal from a corresponding sensor and the vehicle switches from the stop mode to the running mode. The controller controls the two motors to restart the engine, using the start mode and run mode described above.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. A starting system for an internal combustion engine of a vehicle comprising:
a first motor configured to selectively drive either the engine or a first load;
a second motor configured to drive a second load; and
a controller configured to control the first and second motors such that when the first motor drives the engine the second motor is stopped, and when the first motor drives the first load the second motor is controlled to drive the second load.

2. The system of claim 1, wherein the second load is a cooling fan of a cooling system for the engine and the first load is a water pump of the cooling system.

3. The system of claim 2, further comprising a power train control module connected to the controller.

4. The system of claim 2, further comprising a rechargeable battery connected to the controller.

5. The system of claim 2, wherein a second clutch is connected between the first motor and the water pump and a first clutch is connected between the first motor and the engine.

6. The system of claim 5, wherein a gear train is connected between the first motor and the engine.

7. The system of claim 1, wherein the first motor has six phase windings.

8. The system of claim 7, wherein the controller is configured such that when the first motor drives the engine, the controller controls the first motor to operate as a six-phase motor, and when the first motor drives the first load the controller controls the first motor to operate as a three-phase motor.

9. A starting system for an internal combustion engine of a vehicle having a cooling system, the starting system comprising:
a motor connected to the engine and a water pump of the cooling system; and
a controller configured to control the motor to selectively drive either the engine or the water pump.

10. The start system of claim 9, wherein a first clutch is connected between the motor and the engine and a second clutch is connected between the motor and the water pump.

11. The start system of claim 10, wherein a gear train is connected between the engine and the first clutch.

12. The start system of claim 9, further comprising a power train control module connected to the controller, wherein the power train control module shuts down the engine when the engine is not required.

13. The start system of claim 12, further comprising a number of sensors associated with a brake pedal and an accelerator pedal of the vehicle and connected to the power train control module to indicate when the brake pedal and the accelerator pedal are pressed.
